(19) United States
(12) Patent Application Publication
(10) Pub. No.: US 2025/0083565 A1
(43) Pub. Date: Mar. 13, 2025

(54) MANAGING BATTERY STATE OF CHARGE LEVELS ON AN ELECTRIC MACHINE

(71) Applicant: Caterpillar Inc., Peoria, IL (US)

(72) Inventors: Srikar Thaduvayi, Oro Valley, AZ (US); Hua Xu, Dunlap, IL (US); Justin Dale Middleton, Peoria, IL (US)

(73) Assignee: Caterpillar Inc., Peoria, IL (US)

(21) Appl. No.: 18/244,464

(22) Filed: Sep. 11, 2023

(51) Int. Cl. B60L 58/22; B60L 58/13

(52) U.S. Cl. CPC B60L 58/22; B60L 58/13; B60L 2200/40

(57) ABSTRACT

Various techniques to maintain the same state of charge levels between multiple battery strings, manage battery string usage during machine idle/low power conditions, and manage the usage of battery strings with insufficient state of charge level.

### TECHNICAL FIELD

This disclosure relates generally to energy storage systems for electric machines.

### BACKGROUND

Battery electric machines are a type of electric vehicle that rely solely on electric power stored in a battery module to propel and operate the machine. Unlike hybrid vehicles that combine internal combustion engines with electric motors, battery electric machines operate entirely on electricity, making them an environmentally friendly alternative to gasoline or diesel-powered machines. These machines utilize electric motors powered by high-capacity battery modules, which provide the necessary energy to drive the vehicle's traction system, such as include wheels and/or tracks.

Battery modules are the heart of battery electric machines. They are composed of multiple individual battery cells, such as lithium-ion or lithium-polymer, that store electrical energy chemically. These cells are interconnected and packaged together in a compact and robust unit, ensuring efficient energy storage and delivery. The size and capacity of battery modules vary depending on the specific machine and its intended use. Higher-capacity battery modules allow battery electric machines to operate longer on a single charge.

EP2969640B1 describes a system and method for balancing the states of charge between a plurality of energy storage modules in a hybrid vehicle is disclosed. The method comprises determining states of charge of individual energy storage modules in said plurality of energy storage modules operatively connected to a power source in the hybrid electric vehicle. The vehicle is operated using a subset of the plurality of energy storage modules when the states of charge of said subset the plurality of energy storage modules is outside of a tolerance relative to the remaining energy storage modules of said plurality of said energy storage modules. The energy storage modules may be charged or discharged using the method in order to equalize the states of charge of the energy storage modules.

### SUMMARY

This disclosure describes various techniques to maintain the same state of charge (SOC) levels between multiple battery strings, manage battery string usage during machine idle/low power conditions, and manage the usage of battery strings with insufficient state of charge level.

In some aspects, this disclosure is directed to an electrical system for providing electrical power to at least one traction component and at least one accessory component of an electric machine, the electrical system comprising: a battery system configured to supply power to a component of the electric machine, the battery system comprising: a plurality of battery strings, wherein each battery string includes a battery module having at least one battery cell; an electronic control module configured to receive a representation of a state of charge of each battery string, the electronic control module including a control unit configured to: determine which battery string has a highest state of charge; and select, based on a load requirement of the at least one accessory component, the battery string with the highest state of charge to provide power to the at least one accessory component when the highest state of charge exceeds a state of charge of another battery string by a threshold value; and an output coupled to the battery system and configured to supply the electrical power to the at least one accessory component without supplying power to the at least one traction component.

In some aspects, this disclosure is directed to an electrical system for providing electrical power to at least one traction component and at least one accessory component of an electric machine, the electrical system comprising: a battery system configured to supply power to a component of the electric machine, the battery system comprising: a plurality of battery strings, wherein each battery string includes a battery module having at least one battery cell; an electronic control module configured to receive a representation of a state of charge of each battery string, the electronic control module including a control unit configured to: compare states of charge of corresponding battery strings to a threshold; when one of the states of charge is below the threshold, selectively isolate the corresponding battery string so as to prevent the battery string from providing power to the at least one accessory component; and an output coupled to the battery system and configured to supply the electrical power to the at least one accessory component without supplying power to the at least one traction component.

In some aspects, this disclosure is directed to a method for providing electrical power to at least one traction component and at least one accessory component of an electric machine, the method comprising: receiving a representation of a state of charge of each battery string of a plurality battery string; determining which battery string has a highest state of charge; and selecting, based on a load requirement of the at least one accessory component, the battery string with the highest state of charge to provide power to the at least one accessory component when the highest state of charge exceeds a state of charge of another battery string by a threshold value.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a perspective view of an example of a battery powered machine that can implement various techniques of this disclosure.

FIGS. 2A-2B depict a block diagram of an example of an electrical system that can implement various techniques of this disclosure.

FIG. 3 is a block diagram of an example of an electrical connection between battery electronic control modules and a machine electronic control module.

FIG. 4 is a flow diagram of an example of a method for providing electrical power to at least one traction component and at least one accessory component of an electric machine in accordance with this disclosure.

### DETAILED DESCRIPTION

State of charge (SOC) refers to the current amount of stored electrical energy in a battery, expressed as a percentage of its maximum capacity. SOC represents the immediate level of charge available in the battery at a given time. SOC indicates how much energy is remaining in the battery, with 0% indicating a completely discharged battery and 100% indicating a fully charged battery. SOC changes dynamically as the battery is discharged or charged. Monitoring SOC is crucial for estimating the battery's runtime, determining when to recharge, and preventing over-discharging or overcharging.

The present inventors have recognized several problems with battery systems. Currently, it is desirable to maintain the SOC of batteries at the same level between battery systems, where a battery system includes one or more battery strings, and where each battery string includes a battery module having at least one battery cell. Further, it is desirable that the usage of a battery string be managed based on a condition of the machine and the battery. It is also desirable to manage the usage of battery strings with insufficient states of charge.

The present inventors have solved these problems with various techniques described in detail below. This disclosure describes various techniques to maintain the same SOC levels between multiple battery strings, manage battery string usage during machine idle/low power conditions, and manage the usage of battery strings with insufficient state of charge level.

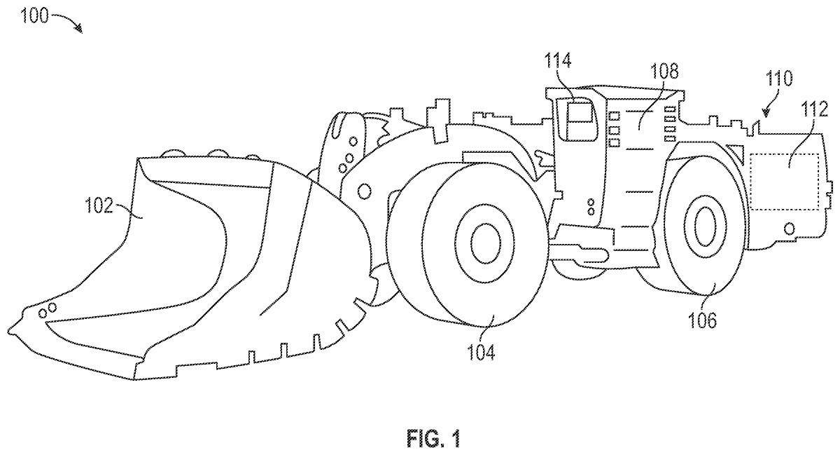

FIG. 1 is a perspective view of an example of an electric machine 100 (at least partially battery powered) that can implement various techniques of this disclosure. FIG. 1 depicts a non-limiting view of an electric machine 100 in the form of a load-haul-dump (LHD) vehicle, such as for mining, including a dump bucket 102, wheels 104, 106, an operator control cabin 108, and a vehicle body 110. The wheels 104, 106 are examples of traction components. In other examples, the electric machine 100 can include traction components such as one or more tracks, in addition to or instead of the wheels.

The electric machine 100, e.g., an electric mine truck, also includes an electrical system 112. The electrical system 112 can include a DC power source, including but not limited to one or more battery strings, which can supply power to, among other things, an electric motor. The electric motor can supply rotational power to one or more systems, such as a system configured to operate various hydraulics of the dump bucket 102. The electrical system 112 can supply power to at least one traction component, such as the wheel 104, 106, and to at least one accessory component 114, such a pump motor, fan, and the like.

In some examples, the electric machine 100 can include electric vehicles, such as cars, trucks, motorcycles, buses, and the like. Although the techniques of this disclosure may be especially suited for use in battery-powered machines, the techniques can be used in hybrid-powered machines.

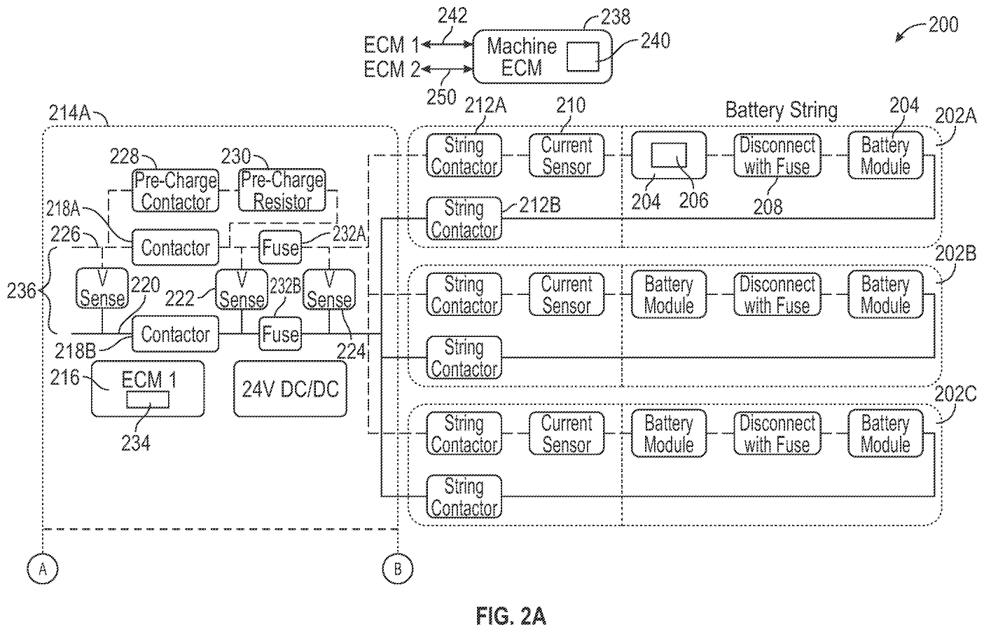

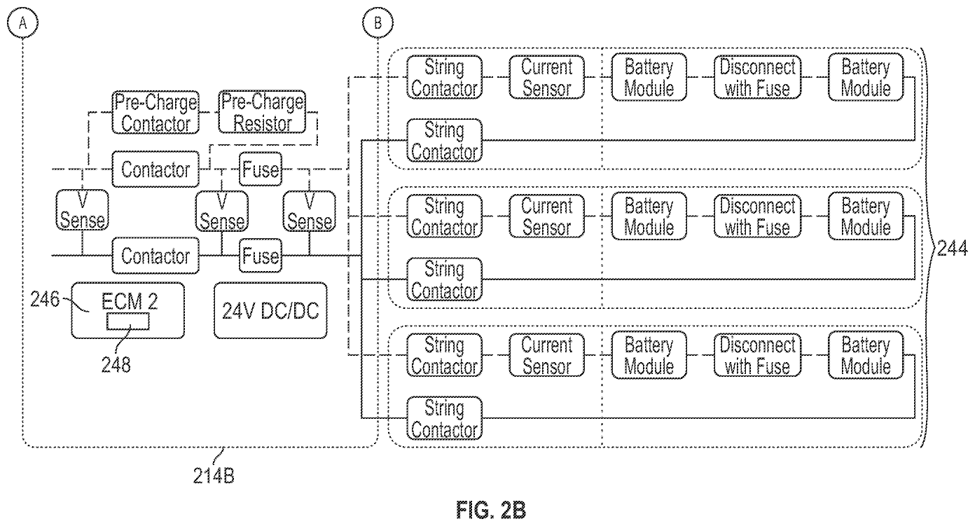

FIGS. 2A-2B depict a block diagram of an example of a battery system 200 that can implement various techniques of this disclosure. The battery system 200 forms part of the electrical system 112 of FIG. 1. The battery system 200 is configured to supply power to one or more components of an electric machine, such as at least one traction component and/or at least one accessory component of the electric machine 100 of FIG. 1.

The battery system 200 includes a plurality of battery strings, such as three battery strings 202A-202C. In some examples, there may be more than three battery strings and in other examples, there may be two battery strings. Each battery string includes one or more battery modules 204 having at least one battery cell 206. Battery modules can be joined in series via an electrical disconnect 208, such a fuse. Each battery string, such as the battery string 202A, can include a current sensor 210, which can be used to monitor the current through the battery string. Battery strings 202B and 202C can be similarly configured, as shown in FIGS. 2A-2B.

The plurality of battery strings 202A-202C can further include string contactors 212A, 212B so as to allow individual ones of the plurality of battery strings to be selectively electrically coupled with or electrically decoupled from a power module 214A. The power module 214A can include an electronic control module 216 (or ECM 216). The ECM 216 performs various functions to manage the battery system 200, as described below.

The power module 214A can also include pack contactors 218A, 218B, which can electrically disconnect all of the battery strings 202A-202C. The power module 214A can also include one or more voltage sensors 220-224 to monitor the voltages per battery string and on the electrical bus 226. The power module 214A can further include a pre-charge contactor 228 and a pre-charge resistor 230 that can be used to control the in-rush current as the battery strings are connected. The power module 214A can further include fuses 232A, 232B to permanently isolate the power module 214A from the plurality of battery strings 202A-202C.

The ECM 216 is electrically coupled to the battery system 200 and is configured to receive the sensed signals, e.g., voltage and current, and output control signals, such as to control the opening and closing of various contactors. For example, the ECM 216 can output a control signal to open various contactors associated with a particular one of the battery strings 202A-202C so as to remove the battery string, such as when the ECM 216 determines that the battery string is unhealthy, e.g., where its SOC is too low.

The ECM 216 is configured to receive a representation of a state of charge of each battery string 202A-202C. In accordance with this disclosure, to maintain the same SOC levels between multiple battery strings, the ECM includes a control unit 234 that is configured to determine which battery string has the highest state of charge of the plurality of battery strings 202A-202C. The control unit 234 is configured to select, based on a load requirement of at least one accessory component, the battery string with the highest state of charge to provide power to the accessory component when the highest state of charge exceeds a state of charge of another battery string by a threshold value.

By way of a non-limiting example for purposes of explanation, assume that the battery string 202A has an SOC of 90%, the battery string 202B has an SOC of 80%, and the battery string 202C has an SOC of 80%. To maintain the same SOC levels between the plurality of battery strings 202A-202C, the control unit 234 can receive data representing the state of charge of each of the plurality of battery strings 202A-202C and determine that the battery string 202A has the highest state of charge among the three battery strings. When the highest state of charge exceeds a state of charge of another battery string by a threshold value, the control unit 234 can then select, based on a load requirement of one or more accessory components, such as a pump, fan, etc., the battery string with the highest state of charge, to provide power to the accessory component.

For example, assume that the threshold value is 2%, which is a difference value or delta between the SOCs of other battery strings. The control unit 234 can then select, based on a load requirement of one or more accessory components, the battery string 202A to provide power to the accessory component because it has the highest state of charge and that state of charge exceeds a state of charge of battery string 202B and/or battery string 202C by the threshold value (10% difference between 90% and 80% exceeds the threshold value of 2%). For example, the control unit 234 can use a load requirement of the accessory component(s) to select a particular battery string to ensure that the battery string has a sufficient SOC available to power the accessory component. For example, the control unit 234 can generate and output a command signal to close a contactor corresponding to the battery string with the highest state of charge. In FIGS. 2A-2B, the control unit 234 can generate and output a control signal to close the string contactors 212A, 212B to select the battery string 202A. Similarly, the control unit 234 can generate and output control signals to open string contactors to deselect the battery strings 202B, 202C.

The electrical system 112 of FIG. 1 can include an output 236 coupled to the battery system 200, such as at the electrical bus 226, which is configured to supply the electrical power to the accessory component(s), e.g., fans, pump motors for hydraulics and/or cooling, etc., without supplying power to the traction component(s), e.g., wheels and/or tracks.

The electrical system 112 of the electric machine 100 of FIG. 1 can further include a machine ECM 238. The ECM 238 can include a control unit 240 and the ECM 238 is in electrical communication with the ECM 216 via communication path 242. The machine ECM 238 can estimate the load during a normal startup and can monitor the load on the electric machine.

As an example, the control unit 240 of the machine ECM 238 can use a speed at which a pump motor is running to determine the electrical load of a pump motor. The control unit 234 is configured to receive data representing the current and voltage information from the various current and voltage sensors in FIGS. 2A-2B and/or speed, torque, etc., which can be communicated to the control unit 240 of the machine ECM 238. The control unit 240 can use the received data to calculate a load requirement of the accessory component(s) or use a lookup data (or other stored data structure) to determine the load requirement. In other examples, the control unit 234 of the battery ECM can perform the calculations or perform the lookup.

The battery ECM 216 can ignore the machine ECM 238 request, if needed. The machine ECM 238 can communicate to the battery ECM 216 if a load is going to be increased (e.g., anticipatory control). In response, the battery ECM 216 can bring all battery strings online, for example, to support the increased demand, or determine that one or more battery strings can be left offline, if needed.

In some examples, when the highest state of charge does not exceed the state of charge of another battery string by the threshold value, the control unit 234 is configured to select all of the battery strings, such as the battery strings 202A-202C. In other words, when the difference (or delta) in SOC between the battery strings does not exceed the threshold value, then the battery strings are sufficiently balanced.

The battery system 200 of FIGS. 2A-2B can include one or more additional battery strings, such as the plurality of battery strings 244, which is similar to the battery strings 202A-202C and, for brevity, will not be described again in detail. The battery system 200 can include a power module 214B electrically coupled with the plurality of battery strings 244. The power module 214B is similar to the power module 214A and, for brevity, will not be described again in detail. The power module 214B can include an ECM 246 having a control unit 248. The ECM 246 performs various functions to manage the battery system 200, as described in this disclosure with respect to ECM 216. The ECM 246 is in electrical communication with the machine ECM 238 via communication path 250. Other examples can include more battery strings and corresponding ECMs.

The ECM 216 and the ECM 246 can provide battery string data and other data to and receive instructions from the machine ECM 238. For example, the machine ECM 238 can monitor accessory loads and communicate that information to one or both of the ECM 216 and the ECM 246 (and additional ECMs, if present).

In some examples, it can be desirable to prevent a battery string from providing power to an accessory component if that battery string has a low SOC, e.g., is unhealthy. The control unit 234 can compare states of charge of corresponding battery strings to a threshold value and, when one of the states of charge is below the threshold value, selectively isolate the corresponding battery string so as to prevent the battery string from providing power to the accessory component(s).

By way of a non-limiting example for purposes of explanation, assume that the battery string 202A has an SOC of 10%, the battery string 202B has an SOC of 80%, and the battery string 202C has an SOC of 80%. Assume that the threshold value is 20%, which is an SOC level. The control unit 234 can receive data representing the state of charge of each of the plurality of battery strings 202A-202C and compare the SOCs to a threshold value, e.g., 20%. Because the SOC of the battery string 202A (10%) is below the threshold value (20%), the control unit 234 can generate and output signals to open the corresponding string contactors 212A, 212B to selectively isolate the battery string 202A.

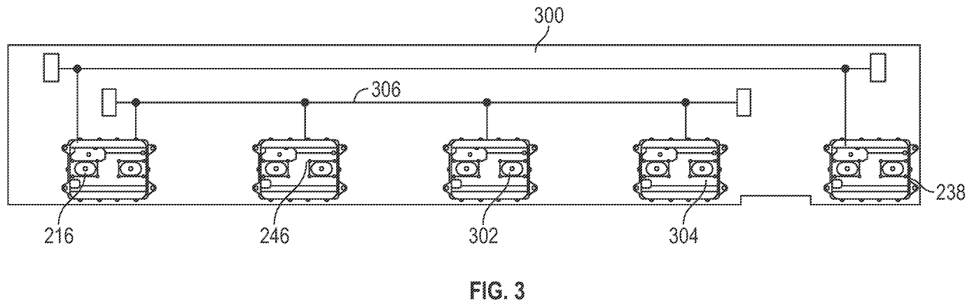

FIG. 3 is a block diagram of an example of an electrical connection between battery electronic control modules and a machine electronic control module. As seen in FIG. 3, the machine ECM 238 (of FIGS. 2A-2B) is in electrical communication with the ECM 216 (of FIGS. 2A-2B) via a first communication bus 300. The battery ECM is in electrical communication with the ECM 246 (of FIGS. 2A-2B) and additional ECMs 302, 304 via a second communication bus 306. Although depicted as a daisy-chain configuration, the battery ECMs and the machine ECM can be electrically coupled in other configurations.

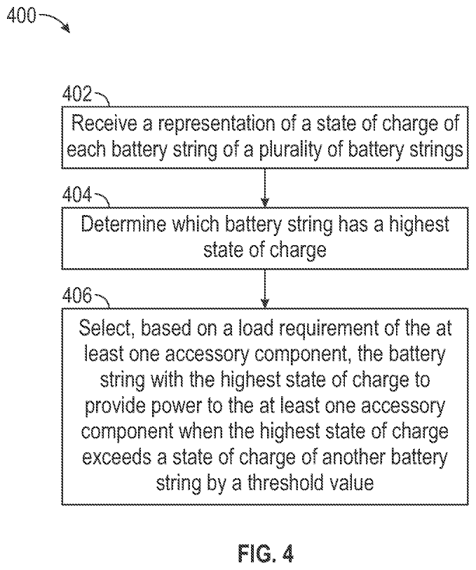

FIG. 4 is a flow diagram of an example of a method 400 for providing electrical power to at least one traction component and at least one accessory component of an electric machine in accordance with this disclosure. In block 402, the method 400 receives a representation of a state of charge of each battery string of a plurality battery string. In block 404, the method 400 determines which battery string has a highest state of charge. In block 406, the method 400 selects, based on a load requirement of the at least one accessory component, the battery string with the highest state of charge to provide power to the at least one accessory component when the highest state of charge exceeds a state of charge of another battery string by a threshold value.

### INDUSTRIAL APPLICABILITY

The present invention relates to techniques for monitoring and managing the state of charge (SOC) of battery systems, which has clear industrial applicability. As described, SOC represents the current charge level of a battery and is critical for estimating runtime, scheduling recharges, and preventing over-discharge/overcharge. The ability to monitor and control SOC provides the practical benefit of optimizing battery usage and extending battery life.

The invention offers solutions to deficiencies in existing battery systems by maintaining consistent SOC levels across battery strings, managing string usage during low power conditions, and regulating strings with insufficient SOC. These techniques have evident real-world applications for improving battery management in various systems, including electric machines.

In summary, the described invention provides an advance in battery monitoring and control technology and has readily apparent industrial uses. The techniques offer tangible solutions to current challenges in battery management across a range of industries. By optimizing SOC, the invention improves battery performance and longevity. Therefore, the information clearly establishes the industrial applicability of the techniques outlined in the present application.

Unless explicitly excluded, the use of the singular to describe a component, structure, or operation does not exclude the use of plural such components, structures, or operations or their equivalents. The use of the terms “a” and “an” and “the” and “at least one” or the term “one or more,” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B” or one or more of A and B”) is to be construed to mean one item selected from the listed items (A or B) or any combination of two or more of the listed items (A and B; A, A and B; A, B and B), unless otherwise indicated herein or clearly contradicted by context. Similarly, as used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

The above detailed description is intended to be illustrative, and not restrictive. The scope of the disclosure should, therefore, be determined with references to the appended claims, along with the full scope of equivalents to which such claims are entitled.

What is claimed is:

1. An electrical system for providing electrical power to at least one traction component and at least one accessory component of an electric machine, the electrical system comprising:
a battery system configured to supply power to a component of the electric machine, the battery system comprising:
a plurality of battery strings, wherein each battery string includes a battery module having at least one battery cell;
an electronic control module configured to receive a representation of a state of charge of each battery string, the electronic control module including a control unit configured to:
determine which battery string has a highest state of charge; and
select, based on a load requirement of the at least one accessory component, the battery string with the highest state of charge to provide power to the at least one accessory component when the highest state of charge exceeds a state of charge of another battery string by a threshold value; and
an output coupled to the battery system and configured to supply the electrical power to the at least one accessory component without supplying power to the at least one traction component.

2. The electrical system of claim 1, wherein the control unit is a first control unit, wherein the electronic control module is a first electronic control module coupled to the battery system and includes the first control unit, and wherein the battery system includes the first electronic control module.

3. The electrical system of claim 1, wherein the control unit is a second control unit, wherein the electronic control module is a second electronic control module coupled to the electric machine and includes the second control unit, and wherein the second electronic control module is in electrical communication with a first electronic control module coupled to the battery system.

4. The electrical system of claim 3, wherein the plurality of battery strings is a first plurality of battery strings, the electrical system further comprising:
a second plurality of battery strings, wherein each battery string of the second plurality of battery strings includes a battery module having at least one battery cell; and
a third electronic control module configured to receive a representation of a state of charge of each battery string of the second plurality of battery strings,
wherein the second electronic control module is in electrical communication with the third electronic control module.

5. The electrical system of claim 1, wherein the control unit is configured to:
determine the load requirement of the at least one accessory component.

6. The electrical system of claim 1, wherein the control unit configured to select, based on the load requirement of the at least one accessory component, the battery string with the highest state of charge to provide power to the at least one accessory component when the highest state of charge exceeds the state of charge of another battery string by the threshold is configured to:
generate and output a command signal to close a contactor corresponding to the battery string with the highest state of charge.

7. The electrical system of claim 1, wherein the control unit is configured to select all of the battery strings when the highest state of charge does not exceed the state of charge of another battery string by the threshold value.

8. The electrical system of claim 1, wherein the threshold value is a first threshold value, and wherein the control unit is further configured to:
compare states of charge of corresponding battery strings to a second threshold value; and
when one of the states of charge is below the second threshold value, selectively isolate the corresponding battery string so as to prevent the battery string from providing power to the at least one accessory component.

9. An electrical system for providing electrical power to at least one traction component and at least one accessory component of an electric machine, the electrical system comprising:
a battery system configured to supply power to a component of the electric machine, the battery system comprising:
a plurality of battery strings, wherein each battery string includes a battery module having at least one battery cell;
an electronic control module configured to receive a representation of a state of charge of each battery string, the electronic control module including a control unit configured to:
compare states of charge of corresponding battery strings to a threshold;
when one of the states of charge is below the threshold, selectively isolate the corresponding battery string so as to prevent the battery string from providing power to the at least one accessory component; and
an output coupled to the battery system and configured to supply the electrical power to the at least one accessory component without supplying power to the at least one traction component.

10. The electrical system of claim 9, wherein the control unit is a first control unit, wherein the electronic control module is a first electronic control module coupled to the battery system and includes the first control unit, and wherein the battery system includes the first electronic control module.

11. The electrical system of claim 9, wherein the control unit is a second control unit, wherein the electronic control module is a second electronic control module coupled to the electric machine and includes the second control unit, and wherein the second electronic control module is in electrical communication with a first electronic control module coupled to the battery system.

12. The electrical system of claim 11, wherein the plurality of battery strings is a first plurality of battery strings, the electrical system further comprising:
a second plurality of battery strings, wherein each battery string of the second plurality of battery strings is a first plurality of battery strings includes a battery module having at least one battery cell; and
a third electronic control module configured to receive a representation of a state of charge of each battery string of the second plurality of battery strings,
wherein the second electronic control module is in electrical communication with the third electronic control module.

13. The electrical system of claim 9, wherein the threshold is a first threshold, and wherein the control unit is further configured to:
determine which battery string has a highest state of charge; and
select, based on a load requirement of the at least one accessory component, the battery string with the highest state of charge to provide power to the at least one accessory component when the highest state of charge exceeds a state of charge of another battery string by a second threshold.

14. The electrical system of claim 13, wherein the control unit is configured to:
determine the load requirement of the at least one accessory component.

15. The electrical system of claim 13, wherein the control unit configured to select, based on the load requirement of the at least one accessory component, the battery string with the highest state of charge to provide power to the at least one accessory component when the highest state of charge exceeds the state of charge of another battery string by the threshold is configured to:
generate and output a command signal to close a contactor corresponding to the battery string with the highest state of charge and open a contact corresponding to an unselected battery string.

16. The electrical system of claim 13, wherein the control unit is configured to select all of the battery strings when the highest state of charge does not exceed the state of charge of another battery string by the second threshold.

17. A method for providing electrical power to at least one traction component and at least one accessory component of an electric machine, the method comprising:
receiving a representation of a state of charge of each battery string of a plurality battery string;
determining which battery string has a highest state of charge; and
selecting, based on a load requirement of the at least one accessory component, the battery string with the highest state of charge to provide power to the at least one accessory component when the highest state of charge exceeds a state of charge of another battery string by a threshold value.

18. The method of claim 17, wherein the threshold value is a first threshold value, the method further comprising:
comparing states of charge of corresponding battery strings to a second threshold value; and
when one of the states of charge is below the second threshold value, selectively isolating the corresponding battery string so as to prevent the battery string from providing power to the at least one accessory component.

19. The method of claim 17, comprising:
selecting all of the battery strings when the highest state of charge does not exceed the state of charge of another battery string by the threshold value.

20. The method of claim 17, wherein selecting, based on the load requirement of the at least one accessory component, the battery string with the highest state of charge to provide power to the at least one accessory component when the highest state of charge exceeds the state of charge of another battery string by the threshold value includes:
generating and outputting a command signal to close a contactor corresponding to the battery string with the highest state of charge.
